(19) United States
(12) Patent Application Publication
(10) Pub. No.: US 2026/0022238 A1
(43) Pub. Date: Jan. 22, 2026

(54) IONOMER RESIN COMPOSITION

(71) Applicant: KURARAY AMERICA, INC., Houston, TX (US)

(72) Inventor: Charles SMITH, Houston, TX (US)

(73) Assignee: KURARAY AMERICA, INC., Houston, TX (US)

(21) Appl. No.: 18/865,745

(22) PCT Filed: Jun. 14, 2023
(86) PCT No.: PCT/US2023/025265

§ 371 Date: Nov. 14, 2024

Related U.S. Application Data
(60) Provisional application No. 63/354,307, filed on Jun. 22, 2022.
(60) Provisional application No. 63/354,335, filed on Jun. 22, 2022.

(51) Int. Cl. C08L 23/0876; B32B 17/10; C08J 5/18

(52) U.S. Cl. CPC C08L 23/0876; B32B 17/10036; B32B 17/10743; B32B 17/10871; C08J 5/18; B32B 2250/40; B32B 2270/00; B32B 2272/00; B32B 2307/40; B32B 2309/02; B32B 2309/12; B32B 2315/08; C08J 2323/08; C08J 2423/08; C08L 2207/20

(57) ABSTRACT

Provided is an ionomer resin composition containing a sodium-neutralized ethylene acid copolymer and a recycled dialkoxysilane adhesion promoter, as well as methods of making and using such compositions. The sodium-neutralized ethylene acid copolymer used is preferably a combination of “fresh” or “virgin” copolymer and recycle copolymer, and the dialkoxysilane adhesion promoter additive used is at least partially present in the form of, and combined with the copolymer in the form of, a recycle material. The described ionomer resin composition has, among many beneficial properties and uses, enhanced adhesion to glass, and is thus particularly suited for use in making interlayers and glass laminates comprising such interlayers.

### CROSS-REFERENCE TO RELATED APPLICATIONS

This application claims priority to U.S. Provisional Application Ser. No. 63/354,307 and to U.S. Provisional Application Ser. No. 63/354,335, both filed Jun. 22, 2022, both incorporated by reference herein in their entireties for all purposes as if fully set forth.

### FIELD OF THE INVENTION

The present invention relates to ionomer resin compositions comprising a sodium-neutralized ethylene acid copolymer and a dialkoxysilane adhesion promoter, and to methods of making and using such compositions. The sodium-neutralized ethylene acid copolymer used is preferably “virgin” or “fresh” copolymer, and the dialkoxysilane adhesion promoter additive used is preferably initially present in the form of, and combined with the copolymer in the form of, a recycle material. Preferably, the sodium-neutralized ethylene acid copolymer is one or a combination of a sodium-neutralized ethylene acid dipolymer and a sodium-neutralized ethylene acid ester terpolymer. The described ionomer resin composition has, among many beneficial properties and uses, enhanced adhesion to glass, and is thus particularly suited for use in making interlayers and glass laminates comprising such interlayers.

### BACKGROUND OF THE INVENTION

Laminated glass is generally made by laminating two pieces of glass onto a plastic interlayer. One particular advantage of laminated glass versus solid glass sheets is impact and shatter resistance due to adhesion of the glass to the interlayer sheet.

In safety glass laminates, optimal adhesion of the interlayer to glass is a balance. Too much adhesion detracts from the ability of the laminate to absorb and dissipate energy during an impact event, and too little adhesion can result in optical defects (at the time of lamination and subsequently), and can also detrimentally affect the ability of the interlayer to retain glass shards on impact.

Many different materials have been used as the plastic interlayer. For example, sheets containing a polyvinyl acetal (polyvinyl butyral) and a plasticizer are widely utilized as an interlayer for laminated glass because they have excellent adhesion-to-glass properties. Laminated glass containing such interlayers can be made with good transparency, mechanical strength, flexibility, acoustic damping and shatter resistance.

At least partially neutralized ethylene acid copolymers (ionomers) have also been used as interlayers for preparing laminated safety glass, for example, as disclosed in U.S. Pat. Nos. 3,404,134, 3,344,014, 7,445,683B2, 7,763,360B2, 7,951,865B1, 7,960,017B2, 8,399,097B2, 8,399,098B2, US2017/0320297A1 US2018/0117883A1, WO2016/076336A1, WO2016/076337A1, WO2016/076338A1 WO2016/076339A1 and WO2016/076340A1.

While ionomer resins can be chosen to produce interlayers having excellent flexural strength and optical properties, the adhesion properties to glass may not be optimal. In particular, because ionomers are neutralized acid copolymers, they do have a tendency to develop lamination defects, particularly in high moisture environments.

For example, when using ionomer resins as interlayers for float glass, adhesion is often satisfactory on the “tin side” but not on the “air side” of the glass, so special precautions need to be taken into account during the lamination process to properly orient such glass sheets to ensure contact of the “tin side” to the interlayer.

It has been proposed to use primers and other surface treatments of the glass and interlayer to help with the adhesion issue (see for example US2016/0159042A1), but this adds cost and complexity to the lamination process, and such surface treatments often result in too much adhesion which, as indicated previously, can detract from the ability of the laminate to absorb and dissipate energy during an impact event.

Ionomer resin modification and compounding with additives have also been attempted. For example, increasing the acid levels of the ethylene acid copolymers does improve the adhesion properties of the ultimate ionomer; however, there are practical and economic limits to how much the acid value can be increased. Additives have also been used with limited success.

In particular, silanes are known to be excellent adhesion promotors to glass in a number of different resin systems. As disclosed in US2011/0105681A1, however, the use of silanes in general with ionomers, and in particular with sodium-neutralized ionomers, creates gel and does not allow for the production of a melt stream allowing for completion of sheet extrusion in a satisfactory manner. That particular publication identified a narrow class of amino group-containing dialkoxysilanes that could be used in combination with only a specific type of zinc-neutralized ionomer.

Commonly-owned US2019/030863A1 provides a sodium-neutralized ethylene acid copolymer ionomer composition containing a specified dialkoxysilane silane additive in a specified amount without the problems identified in US2011/0105681A1, and having enhanced adhesion properties to glass to both the tin-side and air-side of float glass.

Ionomers are thermoplastics and are recyclable. In ideal situations, they can be repeatedly melted and remolded into new products. Processes to recycle ionomeric material are disclosed by D. Sykutera, P. Czyzewski, in Journal of Polish CIMAC, vol 7, no. 3, pp 301-308, Gdansk, 2012; and by J. G. Poulakis, C. D. Papaspyrides, in Adv in Polymer Technology, Vol 19, No 3, 203-209 (2000). Generally, these processes include cooling ionomer and cutting the waste ionomer into appropriate sizes to allow remelt and reprocessing to form injection-molded products. Each heat cycle, however, degrades the polymer, and imparts undesirable properties such as color to the polymer, and the use of these recycled ionomers in interlayers (thin films and sheets) for glass laminates, where clarity is a key parameter, is not disclosed.

Heat cycling would be expected to degrade any silane adhesion promotor remaining in the recycle material. In fact, it would be expected that much of the silane adhesion promotor originally present in the material would have degraded due to environmental exposure during the use of products made from the ionomer, as well as uncontrolled environmental exposure during recycle, as silane groups are known to be sensitive to moisture, oxygen and other environmental factors.

In contrast to this expectation, it has now been found that “used” material originally containing a specified silane adhesion promoter can successfully and advantageously be used as recycle material while still imparting glass adhesion properties, allowing the optimal use of such silanes and ionomers in the preparation of, among other things, thin film and sheets such as interlayers and glass laminates having enhanced interlayer-to-glass adhesion properties. Moreover, as the class of silanes used herein are preferably used at least in part in the form of a recycle material, the advantages described herein are responsible for increasing overall efficiencies, reducing raw material requirements, reducing waste, and saving energy in the production of, e.g., thin films and sheets. While processes to use recycled ionomeric material are known, issues regarding differences between the appearance of laminates made with ionomers without added recycled material and those with added recycled material have not been disclosed. Some of these differences in appearance include, but are not limited to, clarity, haziness, color, modulus, and tensile strength. Additionally, the effect of different cooling cycles on the ionomers with added recycled materials has not been previously described but is herein.

As used herein, where the terms “invention, “present invention,” and the like are used they refer only to the particular embodiment immediately following. They are not broadly limiting overall, or with regard to the several advances in the art described herein.

### SUMMARY OF THE INVENTION

The present invention addresses the above-described problems in one embodiment by providing ionomer resin compositions comprising a blend of a dialkoxysilane adhesion promoter with an ionomer resin, wherein the ionomer resin is
(i) an at least partially sodium-neutralized ethylene acid dipolymer ionomer resin, or
(ii) an at least partially sodium-neutralized ethylene acid ester terpolymer ionomer resin, or
(iii) any combination of (i) and (ii),
and wherein at least a portion of the dialkoxysilane adhesion promotor, and optionally at least a portion of the ionomer resin, is present in the form of a recycle material.

In one embodiment, the sodium-neutralized ethylene acid dipolymer ionomer resin (i) is an at least partially sodium-neutralized ethylene acid dipolymer resin consisting essentially of, or consisting of, copolymerized units of ethylene and at least one α,β-unsaturated carboxylic acid. In another embodiment the sodium-neutralized ethylene acid ester terpolymer ionomer resin (ii) is an at least partially sodium-neutralized ethylene acid terpolymer resin comprising, consisting essentially of, or consisting of copolymerized units of ethylene, at least one α,β-unsaturated carboxylic acid, at least one α,β-unsaturated carboxylic acid ester and, optionally, a derivative of an α,β-unsaturated carboxylic acid other than an ester, such as an amide or an anhydride.

In one embodiment, the dialkoxysilane adhesion promoter is present in the ionomer resin composition in a total amount ranging from about 50 to about 5000 parts per million by weight based on the weight of the ionomer resin(s).

In one embodiment the dialkoxysilane adhesion promoter is substantially evenly distributed within the resin composition. In another embodiment, the ionomer resin composition is a particulate resin composition.

In another embodiment, the recycle material used herein comprises, consists essentially of, or consists of one of the dipolymer and terpolymer ionomer resins described above, at least one dialkoxysilane adhesion promoter, and optional additives.

In one embodiment, the ionomer resin is a combination of virgin material and recycle material.

In another embodiment, the ionomer compositions, films, laminates, etc., described herein comprise both the at least partially sodium-neutralized ethylene acid dipolymer ionomer resin and the at least partially sodium-neutralized ethylene acid ester terpolymer ionomer resin as well as the recycle material containing the dialkoxysilane adhesion promoter.

In all embodiments herein the amount of dialkoxysilane adhesion promoter present in a given composition can be calculated for example based on the amount of recycle material used, knowing the amount of dialkoxysilane adhesion promoter present in the recycle material, and knowing the amount of any additional dialkoxysilane adhesion promoter added thereto. The amount of dialkoxysilane adhesion promoter present in a given composition, relative to the total amount of dipolymer and/or terpolymer present can for example be similarly calculated based on the amount of recycle material used, knowing the amount of dialkoxysilane adhesion promoter present in the recycle material, knowing the amount of any additional dialkoxysilane adhesion promoter added thereto, knowing the amount of dipolymer and/or terpolymer ionomer resin present in the recycle material, if any, and knowing the amount of virgin or fresh dipolymer and/or terpolymer used.

In all embodiments herein, preferably at least a portion of the sodium-neutralized ethylene acid copolymer used (e.g., the dipolymer and terpolymer) is virgin or fresh copolymer.

In another aspect, the present invention provides a first method of producing an ionomer resin composition, said method comprising the step of mixing the above-described recycle material containing a dialkoxysilane adhesion promoter with the above-described sodium-neutralized ethylene acid copolymer(s).

In one embodiment of the above method, the dialkoxysilane compound is substantially evenly distributed within the resin composition. In another embodiment, the mixing step is a melt blending step. In another embodiment, the dipolymer and/or terpolymer ionomer resins are particulate, the mixing step is performed under non-softening conditions for both the dipolymer and terpolymer ionomer resins, and the resin composition is a particulate resin composition.

In another aspect, the present invention provides a method comprising the steps of: coextruding in an extruder the above-described recycle material with the above-described sodium-neutralized ethylene acid dipolymer and/or alkali metal-neutralized ethylene acid ester terpolymer, optionally with one or more additives selected from the group consisting of an ultraviolet absorber, an antioxidant, a light stabilizer, and a colorant, under conditions to melt and intimately mix the recycle material with the dipolymer and/or terpolymer, to produce a melt; and optionally shaping said melt into a film or sheet of a substantially continuous thickness in the longitudinal direction, for example up to about 2.5 mm in thickness.

In one embodiment of this coextrusion method the recycle material is in the form of granules. In another embodiment the dipolymer and/or the terpolymer are in the form of pellets.

In one embodiment the dialkoxysilane compound contains, in addition to two alkoxysilane groups, a carboxylic acid-reactive group. In one embodiment, the carboxylic acid-reactive group is an amino group or a glycidyl group.

In another embodiment, the present invention provides a method of producing sheets of an ionomer resin composition by melt blending one of the above particulate resin compositions under shear to produce a melt blend, then extruding the melt blend through a die into a sheet form, then cooling the sheet form to solidify the resin composition. In one embodiment, the sheet has a top side and a bottom side, and the sheet is optionally embossed with a pattern on one or both of the top and bottom sides prior to solidification.

In other aspects, the present invention provides an interlayer sheet of such resin composition, and a glass laminate made from such interlayer sheet, for example, comprising two sheets of glass having interposed between an interlayer in accordance with the present invention.

In one embodiment, the interlayer sheet is optionally preconditioned at 34° C. and 50% relative humidity, the interlayer is adhered to the air side of a float glass sheet having an air side and a tin side, and the peel adhesion of the interlayer adhered to the air side of the float glass sheet is greater than about 5 N/cm, or greater than about 10 N/cm, or at least about 20 N/cm, measured at 23° C. and 50% RH, and is less than about 100 N/cm, or less than about 90 N/cm, or less than about 80 N/cm, or less than about 70 N/cm.

These and other embodiments, all of which can be used in combination, features and advantages of the present invention will be more readily understood by those of ordinary skill in the art from a reading of the following detailed description.

### DETAILED DESCRIPTION

The present invention relates to a resin composition comprising at least one recycle material, masterbatches thereof, films, sheets, and interlayers prepared therefrom or from masterbatches thereof, glass laminates containing such interlayers, and methods for their production. Further details are provided below.

In the context of the present description, all publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to whom this disclosure pertains. In case of conflict, the present specification, including definitions, will control.

Except where expressly noted, trademarks are shown in upper case.

Unless stated otherwise, all percentages, parts, ratios, etc., are by weight.

Unless stated otherwise, pressures expressed in psi units are gauge, and pressures expressed in kPa units are absolute. Pressure differences, however, are expressed as absolute (for example, pressure 1 is 25 psi higher than pressure 2).

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, as well as all integers and fractions within the range. It is not intended that the scope of the present disclosure be limited to the specific values recited when defining a range. As an example, a stated range of 1-10 fully describes and includes the independent subrange 3.4-7.2.

When the term “about” is used, it is used to mean a certain effect or result can be obtained within a certain tolerance, and the skilled person knows how to obtain the tolerance. When the term “about” is used in describing a value or an end-point of a range, the disclosure should be understood to include the specific value or end-point referred to.

As used herein, the terms “comprises,” “comprising,” “includes,” “including,” “has,” “having,” “contains,” “containing,” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Optional additives as defined herein, at a level that is appropriate for such additives, and minor impurities, are not excluded from an embodiment by the term “consisting essentially of” unless they materially affect the basic and novel characteristic(s) of the embodiment in question.

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise.

The term “predominant portion” or “predominantly”, as used herein, unless otherwise defined herein, means greater than 50% of the referenced material. If not specified, the percent is on a molar basis when reference is made to a molecule (such as hydrogen and ethylene), and otherwise is on a weight basis (such as for additive content).

The term “substantial portion” or “substantially”, as used herein, unless otherwise defined, means all or almost all or the vast majority, as would be understood by the person of ordinary skill in the context used. It is intended to take into account some reasonable variance from 100% that would ordinarily occur in industrial-scale or commercial-scale situations.

The term “depleted” or “reduced” is synonymous with reduced from originally present. For example, removing a substantial portion of a material from a stream would produce a material-depleted stream that is substantially depleted of that material. Conversely, the term “enriched” or “increased” is synonymous with greater than originally present.

The term “virgin” as used herein refers to a generally pure material that has been newly created. The form of such materials may vary depending upon their method of making. Simply changing only the physical form of such materials by, e.g., physical or thermal means (e.g. grinding, chopping, melting, etc.), without more (for example, chemical change, degradation, mixing in of other materials, etc.), does not change their “virgin” characteristic.

As used herein, the term “granule” means a particle ranging from a highly irregular shape to spherical. The particle ‘size’ can be defined as a weight per 100 particles. In one embodiment particle ‘size’ is from about 0.01 to 10 grams. In another embodiment, suitably sized recycle material granules (particles), while generally not limited, can range in size from about 0.1 mm, or from about 0.2 mm, to about 5 mm, or to about 4 mm, or to about 2 mm, or to about 1 mm. A granule may be porous and may also be comprised of a collection of smaller particles that are ‘clumped’ or somewhat ‘fused’ together so physically it behaves as a larger particle/granule.

As used herein, the term “pellet” means a polymer resin, generally of a cylindrical shape (strand cut) or close to spherical shape (e.g. underwater melt-cut) with a weight of 0.1 to 10 grams per 100 pellets.

As used herein, the term “fresh” refers to a generally pure material that has been newly made or as received from a vendor and that has not been through any post processing in an attempt to create other forms/shapes or thermal treatments causing melting of the resin.

As used herein, the term “intimately mix,” “intimately mixing,” “intimately mixed,” and “intimate mixing” means combining or the combination of two or more polymeric materials—for example virgin ionomer and recycle material—so that optimum optical distortion parameters are achieved. Thermal treatment (melt mixing, etc.) typically is involved. The measurement of the optical distortion can be by any practical method, including but not limited to the “shadowgraph” technique. Shadowgraph is a sensitive visualization method which can reveal optical non-uniformities within transparent materials, generally by shadows cast by disturbances when light rays are refracted. Another common practice is judging the degree of optical distortion present when viewing a ‘checkerboard’ target grid with and without the sample glass laminate being placed in the direct line-of-sight.

As used herein, the term “shaping” as it refers to polymeric materials means forming the materials into films and sheets. Generally, films are about 0.01 to about 0.25 mm thick, and sheets are about 0.25 mm to about 10 mm thick.

As used herein, the term “longitudinal direction” means in the principle direction of material flow from the film or sheet manufacturing process. This is also sometimes referred to as “machine direction” in the case of an extrusion process creating melt that is formed into film or sheet.

As used herein, the terms “plastic” and “polymer” are used interchangeably. While it is recognized that the term “plastic” can refer to a specific type of polymer and is generally composed of long chains of polymers, and polymers are composed of smaller, uniform molecules, for the present invention, both terms can be used interchangeably.

Measurements of haze, YID and other properties are made in glass laminate form. The combination of haze and yellowness index (YID), especially with a quick cooling profile can have little difference in haze but large difference in YID. Substantially all (about 100%) of each resin can have acceptable YID, but combination of the two resins can have increased yellowness. This can be especially important for mixing in recycle material which has a different thermal profile. Differences are noted between “regular” cooling and “quick” cooling, as well as when different resins are combined, as well as the amounts of each resin and the cooling method that is used. The ionomer resins can have blue colorant added (to make the interlayer film/sheetingappear less yellow), but this is an added step and the addition of such would only compensate for the degree of yellowness at a given compositional blend and cooling rate. Additionally, this approach changes the ‘color’ of the resin towards ‘green’ or even ‘grey’, and would in substantially all cases, reduce the overall light transmission of the article which would further create a distinction between resins blends with or without the blue colorant. Additionally, the refractive index (RI) of each resin is important, especially for haze. This is also generally mixing related. The thickness of the glass laminate interlayer must also be considered, as well as any effects resulting from the extrusion method and resin degradation.

As used herein, the terms “recycle material” and “recycle polymeric material” each refers to polymeric material that contains at least one dialkoxysilane adhesion promoter and which has been recovered from a previously produced polymeric material. The previously produced polymeric material can be in any form, and can be or can include waste material from a process used to make it, i.e., seconds, trimmings and the like. This polymeric material contains not only one or more polymer(s) but also at least one dialkoxysilane adhesion promoter and optionally one or more further additives. Therefore, when this polymeric material is recycled, the at least one dialkoxysilane adhesion promoter and optional further additives are also considered “recycled”. Recycle polymeric material can also be obtained from down-stream manufacturing operations, such as trims being derived from the conversion process of film and sheeting being fabricated into glass laminates. Additionally, it is possible that polymeric materials collected can be reprocessed to filter out contaminates through a secondary extrusion process to create material suitable for use.

As used herein, the term “copolymer” refers to polymers comprising copolymerized units resulting from copolymerization of two or more comonomers. In this connection, a copolymer may be described herein with reference to its constituent comonomers or to the amounts of its constituent comonomers, for example “a copolymer comprising ethylene and 15 weight % of acrylic acid”, or a similar description. Such a description may be considered informal in that it does not refer to the comonomers as copolymerized units; in that it does not include a conventional nomenclature for the copolymer, for example International Union of Pure and Applied Chemistry (IUPAC) nomenclature; in that it does not use product-by-process terminology; or for another reason. As used herein, however, a description of a copolymer with reference to its constituent comonomers or to the amounts of its constituent comonomers means that the copolymer contains copolymerized units (in the specified amounts when specified) of the specified comonomers. It follows as a corollary that a copolymer is not the product of a reaction mixture containing given comonomers in given amounts, unless expressly stated in limited circumstances to be such.

The term “dipolymer” refers to polymers consisting essentially of two monomers, and the term “terpolymer” refers to polymers comprising at least three monomers.

The term “acid copolymer” as used herein refers to a copolymer comprising copolymerized units of an α-olefin, an α,β-ethylenically unsaturated carboxylic acid, and optionally other suitable comonomer(s) such as, for example, an α,β-ethylenically unsaturated carboxylic acid ester.

The term “(meth)acrylic”, as used herein, alone or in combined form, such as “(meth)acrylate”, refers to acrylic or methacrylic, for example, “acrylic acid or methacrylic acid”, or “alkyl acrylate or alkyl methacrylate”.

The term “ionomer” as used herein generally refers to a polymer that comprises ionic groups that are carboxylate salts, for example, ammonium carboxylates, alkali metal carboxylates, alkaline earth carboxylates, transition metal carboxylates and/or combinations of such carboxylates. Such polymers are generally produced by partially or fully neutralizing the carboxylic acid groups of precursor or parent polymers that are acid copolymers, as defined herein, for example by reaction with a base. The alkali metal ionomer as used herein is a sodium ionomer, for example a copolymer of ethylene and methacrylic acid, wherein all or a portion of the carboxylic acid groups of the copolymerized methacrylic acid units are neutralized, and substantially all of the neutralized carboxylic acid groups are in the form of sodium carboxylates.

For convenience, many elements of the present invention are discussed separately, lists of options may be provided and numerical values may be in ranges; however, for the purposes of the present disclosure, that should not be considered as a limitation on the scope of the disclosure or support of the present disclosure for any claim of any combination of any such separate components, list items or ranges. Unless stated otherwise, each and every combination possible with the present disclosure should be considered as explicitly disclosed for all purposes.

Although methods and materials similar or equivalent to those described herein can be used in the practice or testing of the present disclosure, suitable methods and materials are described herein. The materials, methods, and examples herein are thus illustrative only and, except as specifically stated, are not intended to be limiting.

### Dialkoxysilane Adhesion Promoter

Adhesion promotors suitable for use in accordance with the various embodiments of the present invention compositions, masterbatches, methods, films, sheets, interlayers, laminates, etc., are dialkoxysilanes. Without being held to theory, it is believed that the hydrolyzed silanol portion of the silane can form an adhesive bond with a glass surface (silanols), thereby enhancing the adhesive force at the interface between the polymer and glass surface. The remaining portion of the silane molecule should then ‘anchor’ in some fashion and to some degree, with the surrounding ionomer resin ‘matrix’. One way to achieve this is to choose functional groups which would interact in a favorable manner to allow the silane to either bond, chemically or through ionic or hydrogen bonding or sufficient van der Waals forces, or be of a size and shape that sterically, can “bridge” between the interlayer and glass surface, thereby increasing the adhesion over the same interlayer without the advantageous silane additive.

In one embodiment, each of the alkoxy groups of the dialkoxysilanes individually contains from 1 to 3 carbon atoms. Suitable examples include diethoxydimethylsilane, diethoxyl(methyl)vinylsilane, 1,3-diethoxy-1,1,3,3-tertramethyldisiloxane, dimethoxydimethylsilane, dimethoxylmethylvinylsilane, methyldiethoxysilane, diisopropyldimethoxysilane, dicyclopentyldimethoxysilane, γ-aminopropyl-N-cyclohexylmethyldimethoxysilane, 3-aminopropylmethyldimethoxysilane, N-phenyl-3-aminopropylmethyldimethoxysilane, N-phenyl-3-aminopropylmethyldiethoxysilane, N-(3-(aminoethyl)-γ-aminopropylmethyldimethoxysilane and 3-glycidoxypropylmethyldiethoxysilane.

In another embodiment, in addition to the alkoxy groups the dialkoxysilanes also contain an “active” chemical group for bonding into an ionomer resin matrix, for example, a carboxylic acid-reactive group such as an amino group or a glycidyl group. Suitable examples include γ-aminopropyl-N-cyclohexylmethyldimethoxysilane, 3-aminopropylmethyldimethoxysilane, N-phenyl-3-aminopropylmethyldimethoxysilane, N-phenyl-3-aminopropylmethyldiethoxysilane, N-β-(aminoethyl)-γ-aminopropylmethyldimethoxysilane and 3-glycidoxypropylmethyldiethoxysilane.

Desirably the dialkoxysilane, in pure form, is a liquid under ambient conditions (for example, at 20° C.). Specific such examples include N-β-(aminoethyl)-γ-aminopropylmethyldimethoxysilane (CAS #3069-29-2) and 3-glycidoxypropylmethyldiethoxysilane (CAS #2897-60-1).

In preferred embodiments of the present invention at least a portion of, or a predominant portion, or substantially all of the dialkoxysilane adhesion promoter is present in, and used in the form of, a recycle material—for example a dipolymer and/or terpolymer ionomer that contains at least one dialkoxysilane adhesion promoter and which has been recovered from a previously produced polymeric material. The number and type of additives present therein in addition to the dialkoxysilane adhesion promoter (e.g., antimicrobials, anti-fog additives, antioxidants, fillers, flame retardants, anti-slip agents, etc. is not limited so long as they do not materially affect the optical properties of the laminates containing interlayers made form the compositions of the present invention.

Additional “fresh” dialkoxysilane adhesion promotor may also be used as required.

### Ionomers

In certain embodiments of the present invention at least one sodium-neutralized ethylene·α,β-unsaturated carboxylic acid copolymer (ionomer) is present. A preferred ionomer is a dipolymer having constituent units derived from ethylene and constituent units derived from an α,β-unsaturated carboxylic acid, in which at least a part of the constituent units derived from the α,β-unsaturated carboxylic acid are neutralized with a sodium ion. Another preferred ionomer is a terpolymer having constituent units derived from ethylene, constituent units derived from an α,β-unsaturated carboxylic acid, constituent units derived from an α,β-ethylenically unsaturated carboxylic acid ester, and optionally constituent units derived from a derivative of an α,β-unsaturated carboxylic acid other than an ester thereof, such as an amide or anhydride thereof, in which at least a part of the constituent units derived from the α,β-unsaturated carboxylic acid are neutralized with a sodium ion. In certain embodiments the dipolymer is the sole ionomer in the invention composition, film, etc. In certain embodiments the terpolymer is the sole ionomer in the invention composition, film, etc.

In preferred embodiments of both the preferred dipolymer and the preferred terpolymer, a content proportion of the constituent units derived from an α,β-unsaturated carboxylic acid is typically 2% by mass or more, or 5% by mass or more (based on total copolymer mass), including 7, 10, 12, 14, 15 and 18% by mass or more. In addition, the content proportion of the constituent units derived from an α,β-unsaturated carboxylic acid is typically 30%, 27%, 25%, 23%, or 22% by mass or less (based on total copolymer mass).

Examples of the α,β-unsaturated carboxylic acid constituting the preferred dipolymer and terpolymer ionomers include, without limitation, acrylic acid, methacrylic acid, itaconic acid, maleic acid, fumaric acid, and mixtures of two or more thereof. In one embodiment, the α,β-ethylenically unsaturated carboxylic acid is selected from acrylic acid, methacrylic acid, and mixtures thereof. In another embodiment, the α,β-ethylenically unsaturated carboxylic acid is methacrylic acid.

The preferred terpolymer further comprises copolymerized units of one or more α,β-ethylenically unsaturated carboxylic acid esters. Alkyl esters having 3 to 10, or 3 to 8 carbons, are typically used. Specific examples of suitable esters of unsaturated carboxylic acids include, without limitation, methyl acrylate, methyl methacrylate, ethyl acrylate, ethyl methacrylate, propyl acrylate, propyl methacrylate, isopropyl acrylate, isopropyl methacrylate, n-butyl acrylate, n-butyl methacrylate, isobutyl acrylate, isobutyl methacrylate, tert-butyl acrylate, tert-butyl methacrylate, octyl acrylate, octyl methacrylate, undecyl acrylate, undecyl methacrylate, octadecyl acrylate, octadecyl methacrylate, dodecyl acrylate, dodecyl methacrylate, 2-ethylhexyl acrylate, 2-ethylhexyl methacrylate, isobornyl acrylate, isobornyl methacrylate, lauryl acrylate, lauryl methacrylate, 2-hydroxyethyl acrylate, 2-hydroxyethyl methacrylate, glycidyl acrylate, glycidyl methacrylate, dimethyl maleate, diethyl maleate, dibutyl maleate, dimethyl fumarate, diethyl fumarate, dibutyl fumarate, dimethyl fumarate, vinyl acetate, vinyl propionate, and mixtures of two or more thereof. In one embodiment, the additional comonomers are selected from methyl acrylate, methyl methacrylate, n-butyl acrylate, n-butyl methacrylate, isobutyl acrylate, isobutyl methacrylate, glycidyl methacrylate, vinyl acetate, and mixtures of two or more thereof. In another embodiment, one or more of n-butyl acrylate, n-butyl methacrylate, isobutyl acrylate and isobutyl methacrylate are used. In another embodiment, one or both of n-butyl acrylate and isobutyl acrylate are used.

In one embodiment the preferred dipolymer and terpolymer each independently have a melt flow rate (MFR) of from about 1, or from about 2, to about 4000 g/10 min, or to 1000 g/10 min, or to about 400 g/10 min, as determined in accordance with ASTM method D1238-89 at 190° C. and 2.16 kg.

One of ordinary skill is capable of synthesizing all of the described ionomers herein, including the preferred dipolymers and terpolymers herein, based on their chemical descriptions, optionally in view of the disclosures in, for example, U.S. Pat. Nos. 3,404,134, 5,028,674, 6,500,888B2, 6,518,365B1, 8,334,033B2 and 8,399,096B2. In one embodiment, a method described in U.S. Pat. No. 8,399,096B2 is used, and a sufficiently high level and complementary amount of the derivative of the second α,β-ethylenically unsaturated carboxylic acid is present in the reaction mixture.

In one embodiment, to obtain useful dipolymer and terpolymer ionomers their ethylene acid copolymer pecursors are partially neutralized by reaction with one or more bases. An example of a suitable procedure for neutralizing the ethylene acid copolymers is described in U.S. Pat. Nos. 3,404,134 and 6,518,365B1. After neutralization, about 1%, or about 10%, or about 15%, or about 20%, to about 90%, or to about 60%, or to about 55%, or to about 30%, of the hydrogen atoms of carboxylic acid groups present in the ethylene acid copolymer precursor are replaced by other cations. Stated alternatively, about 1%, or about 10%, or about 15%, or about 20%, to about 90%, or to about 60%, or to about 55%, or to about 30%, of the total content of the carboxylic acid groups present in the ethylene acid copolymer precursor are neutralized. In another alternative expression, the acid groups are neutralized to a level of about 1%, or about 10%, or about 15%, or about 20%, to about 90%, or to about 60%, or to about 55%, or to about 30%, based on the total content of carboxylic acid groups present in the ethylene acid copolymer precursors as calculated or measured for the non-neutralized ethylene acid copolymer precursors. The neutralization level can be tailored for the specific end-use.

The counterions to the carboxylate anions in the ionomer are sodium cations. In one embodiment the ionomers used in the present invention are substantially sodium-neutralized ionomers, with counterions other than sodium cations optionally present in small amounts of less than 5 equivalent %, or less than 3 equivalent %, or less than 2 equivalent %, or less than 1 equivalent %, based on the total equivalents of carboxylate groups in the ionomer.

Suitable cations other than alkali metal cations include any positively charged species that is stable under the conditions in which the ionomer composition is synthesized, processed and used. Suitable cations may be used in combinations of two or more. Typically, such other cations are metal cations, which may be monovalent, divalent, trivalent, or multivalent. Monovalent metal cations include but are not limited to cations of potassium, lithium, silver, mercury, copper, and the like. Divalent metal cations include but are not limited to cations of beryllium, magnesium, calcium, strontium, barium, copper, cadmium, mercury, tin, lead, iron, cobalt, nickel, zinc, and the like. Trivalent metal cations include but are not limited to cations of aluminum, scandium, iron, yttrium, and the like. Multivalent metal cations include but are not limited to cations of titanium, zirconium, hafnium, vanadium, tantalum, tungsten, chromium, cerium, iron, and the like. When the metal cation is multivalent, complexing agents such as stearate, oleate, salicylate, and phenolate radicals may be included, as described in U.S. Pat. No. 3,404,134. Typically, when present, the metal cations used are monovalent or divalent metal cations, such as lithium, magnesium, zinc, potassium, and combinations of one or more of these metal cations.

In one embodiment, counterions other than sodium are present in at most “contaminant” amounts, as one would typically find in industrial situations, as would be recognized by persons of ordinary skill in the relevant art.

The sodium-neutralized ethylene acid dipolymer and terpolymer are ionomers and preferably have a melt index, as determined in accordance with ASTM method D1238-89 at 190° C. and 2.16 kg, that is lower than that of its corresponding ethylene acid copolymer precursor. The ionomer's melt index depends on a number of factors, including the melt index of the ethylene acid copolymer, the amount of copolymerized acid, the neutralization level, the identity of the cation and its valency. Moreover, the desired value of the ionomer's melt index may be determined by its intended end use. Typically, however, the ionomer has a melt index of about 1000 g/10 min or less, or about 750 g/10 min or less, or about 500 g/10 min or less, or about 250 g/10 min or less, or about 100 g/10 min or less, or about 50 g/10 min or less, or about 25 g/10 min or less, or about of 20 g/10 min or less, or about 10 g/10 min or less, or about 7.5 g/10 min or less, as determined in accordance with ASTM method D1238-89 at 190° C. and 2.16 kg.

In one embodiment, a preferred dipolymer consists essentially of, or consists of, copolymerized units of (i) ethylene, and (ii) from about 10 wt %, or from about 15 wt %, or from about 18 wt %, or from about 20 wt %, to about 30 wt %, or to about 25 wt %, or to about 23 wt % or to about 22 wt %, of at least one α,β-unsaturated carboxylic acid having 3 to 10 carbon atoms, wherein the weight percentages of the copolymerized units are based on the total weight of the dipolymer and the sum of the weight percentages of the copolymerized units is 100 wt %, and wherein at least a portion of carboxylic acid groups of the α,β-unsaturated carboxylic acid are neutralized to form an ionomer comprising carboxylate groups having sodium counterions.

In one embodiment, a preferred terpolymer comprises, consists essentially of, or consists of copolymerized units of: (i) ethylene, (ii) from about 10 wt %, or from about 15 wt %, or from about 18 wt %, or from about 20 wt %, to about 30 wt %, or to about 25 wt %, or to about 23 wt % or to about 22 wt %, of at least one α,β-unsaturated carboxylic acid having 3 to 10 carbon atoms, (iii) from about 2 wt %, or from about 3 wt %, or from about 4 wt %, or from about 5 wt %, to about 15 wt %, or to about 12 wt %, or to about 11 wt %, or to about 10 wt %, of at least one α,β-unsaturated carboxylic acid ester having 3 to 10 carbon atoms, and (iv) optionally a derivative of an α,β-unsaturated carboxylic acid other than (iii) in an amount such that (iii)+(iv) is about 15 wt % or less, or about 12 wt % or less, or about 11 wt % or less, wherein the weight percentages of the copolymerized units are based on the total weight of the terpolymer and the sum of the weight percentages of the copolymerized units is 100 wt %, and wherein at least a portion of carboxylic acid groups of the α,β-unsaturated carboxylic acid are neutralized to form an ionomer comprising carboxylate groups having sodium counterions.

Such terpolymer ionomers are generally disclosed in WO2015/199750A1, WO2014/100313A1 and US2017/0320297A1.

In one embodiment of a preferred dipolymer and/or terpolymer the α,β-unsaturated carboxylic acid is methacrylic acid.

In one embodiment of a preferred terpolymer, the α,β-unsaturated carboxylic acid ester is n-butyl acrylate, isobutyl acrylate or a mixture thereof.

In one embodiment of a preferred terpolymer it consists of, or consists essentially of, copolymerized units of (i), (ii) and (iii).

In one embodiment, both of the dipolymer ionomer and terpolymer ionomer resins described herein are present, and the weight ratio of alkali metal-neutralized ethylene acid dipolymer ionomer resin to alkali metal-neutralized ethylene acid ester terpolymer ionomer resin (w/w dipolymer/terpolymer), based on total weight of dipolymer and terpolymer, is not particularly limited. In one embodiment, the weight ratio of alkali metal-neutralized ethylene acid dipolymer ionomer resin to alkali metal-neutralized ethylene acid ester terpolymer ionomer resin (w/w dipolymer/terpolymer) in the composition, based on total weight of dipolymer and terpolymer, is 0.1/99.9 to 99.9/0.1, inclusive of 0.5/99.5-99.5/0.5, 1/99-99/1, 3/97-97/3, 5/95-95/5, 10/90-90/10, 15/85-85/15, 20/80-80/20, 25/75-75/25, 30/70-70/30, 35/65-65/35, 40/60-60/40, 45/55-55/45, and 50/50.

In one embodiment, one of dipolymer (i) or terpolymer (ii) is from about 5 wt % to about 30 wt %, or to about 25 wt %, to about 20 wt %, to about 15 wt %, or to about 10 wt %, based on the combined weight of (i)+(ii). In another embodiment, one of (i) or (ii) is from about 10 wt % to about 30 wt %, or to about 25 wt %, to about 20 wt %, or to about 15 wt %, based on the combined weight of (i)+(ii). In another embodiment, one of (i) or (ii) is from about 15 wt % to about 30 wt %, or to about 25 wt %, to about 20 wt %, based on the combined weight of (i)+(ii). In another embodiment, one of (i) or (ii) is from about 20 wt % to about 30 wt %, or to about 25 wt %, based on the combined weight of (i)+(ii). In another embodiment, one of (i) or (ii) is from about 25 wt % to about 30 wt %, based on the combined weight of (i)+(ii).

In one embodiment only one of the dipolymer and terpolymer ionomers described herein is present, and the total amount of dipolymer or terpolymer present is, based on the total weight of all polymers of any type present, all, or substantially all, of the composition, sheet, film, laminate, etc.

Although a critical minimum level of adhesion is necessary to maintain sufficient laminate integrity (e.g. preventing delamination defects) and sufficient retention of glass in a post-fractured state, optimization or adjustment of the impact performance of the resulting laminate can be made by intent. Though an optimal addition amount of the adhesion modifier (cumulative) varies with the additive to be used and the resin to be adhesion modified, it is preferably adjusted in such a manner that an adhesive force of the resulting laminate to a glass is generally adjusted to about 3 or more and about 10 or less in a pummel test (described in WO03/033583A1 or the like). In particular, in the case where high penetration resistance is required, the addition amount of the adhesion modifier is more preferably adjusted in such a manner that the adhesive force is about 3 or more and about 6 or less, whereas in the case where high glass shattering preventing properties are required, the addition amount of the adhesion modifier is more preferably adjusted in such a manner that the adhesive force is about 7 or more and about 10 or less.

### Other Additives

Other than the aforementioned dialkoxysilanes, embodiments of the present invention may further optionally contain one or more other additives including, for example, an antioxidant, an ultraviolet ray absorber, a photostabilizer, an antiblocking agent, a pigment, a dye, a heat shielding material (infrared ray absorber) and the like, or mixtures thereof. Such other additives are in a general sense well known to those of ordinary skill in the relevant art.

Examples of the antioxidant include phenol-based antioxidants, phosphorus-based antioxidants, sulfur-based antioxidants, and the like. Of those, phenol-based antioxidants are preferred, and alkyl-substituted phenol-based antioxidants are especially preferred.

Examples of the phenol-based antioxidant include acrylate-based compounds, such as 2-t-butyl-6-(3-t-butyl-2-hydroxy-5-methylbenzyl)-4-methylphenyl acrylate and 2,4-di-t-amyl-6-(1-(3,5-di-t-amyl-2-hydroxyphenyl)ethyl)phenyl acrylate; alkyl-substituted phenol-based compounds, such as 2,6-di-t-butyl-4-methylphenol, 2,6-di-t-butyl-4-ethylphenol, octadecyl-3-(3,5-di-t-butyl-4-hydroxyphenyl)propionate, 2,2′-methylene-bis(4-methyl-6-t-butylphenol), 4,4′-butylidene-bis(4-methyl-6-t-butylphenol), 4,4′-butylidene-bis(6-t-butyl-m-cresol), 4,4′-thiobis(3-methyl-6-t-butylphenol), bis(3-cyclohexyl-2-hydroxy-5-methylphenyl)methane, 3,9-bis(2-(3-(3-t-butyl-4-hydroxy-5-methylphenyl)propionyloxy)-1,1-dimethylethyl)-2,4,8,10-tetraoxaspiro[5.5]undecane, 1,1,3-trix(2-methyl-4-hydroxy-5-t-butylphenyl)butane, 1,3,5-trimethyl-2,4,6-tris(3,5-di-t-butyl-4-hydroxybenzyl)benzene, tetrakis(methylene-3-(3′,5′-di-t-butyl-4′-hydroxyphenyl)propionate)methane and triethylene glycol bis(3-(3-t-butyl-4-hydroxy-5-methylphenyl)propionate); triazine group-containing phenol-based compounds, such as 1,3,5-tris(2,6-dimethyl-3-hydroxy-4-t-butylbenzyl)-1,3,5-triazine-2,4,6(1H,3H,5H)-trione, 6-(4-hydroxy-3,5-di-t-butylanilino)-2,4-bis-octylthio-1,3,5-triazine, 6-(4-hydroxy-3,5-dimethylanilino)-2,4-bis-octylthio-1,3,5-triazine, 6-(4-hydroxy-3-methyl-5-t-butylanilino)-2,4-bis-octylthio-1,3,5-triazine and 2-octylthio-4,6-bis-(3,5-di-t-butyl-4-oxyanilino)-1,3,5-triazine; and the like.

Examples of the phosphorus-based antioxidant include monophosphite-based compounds, such as triphenyl phosphite, diphenylisodecyl phosphite, phenyldiisodecyl phosphite, tris(nonylphenyl) phosphite, tris(dinonylphenyl) phosphite, tris(2-t-butyl-4-methylphenyl) phosphite, tris(2,4-di-t-butyl) phosphite, tris(cyclohexylphenyl) phosphite, 2,2-methylenebis(4,6-di-t-butylphenyl)octyl phosphite, 9,10-dihydro-9-oxa-10-phosphaphenanthrene-10-oxide, 10-(3,5-di-t-butyl-4-hydroxybenzyl)-9,10-dihydro-9-oxa-10-phosphaphenanthrene-10-oxide and 10-decyloxy-9,10-dihydro-9-oxa-10-phosphaphenanthrene; diphosphite-based compounds, such as 4,4′-butylidene-bis(3-methyl-6-t-butylphenyl-di-tridecylphosphite), 4,4′-isopropylidene-bis(phenyl-di-alkyl(C12-C15) phosphite), 4,4′-isopropylidene-bis(diphenylmonoalkyl(C12-C15)phosphite), 1,1,3-tris(2-methyl-4-di-tridecylphosphite-5-t-butylphenyl)butane and tetrakis(2,4-di-t-butylphenyl)-4,4′-biphenylene phosphite; and the like. Of those, monophosphite-based compounds are preferred.

Examples of the sulfur-based antioxidant include dilauryl 3,3′-thiodipropionate, distearyl 3,3-thiodipropionate, lauryl stearyl 3,3′-thiodipropionate, pentaerythritol-tetrakis-(β-lauryl-thiopropionate), 3,9-bis(2-dodecylthioethyl)-2,4,8,10-tetraoxaspiro[5.5]undecane, and the like.

These antioxidants can be used solely or in combination of two or more thereof. In the final resin composition, the antioxidant utilized is typically about 0.001 parts by weight or more, or about 0.01 parts by weight or more, based on 100 parts by weight of the ionomer resin. In addition, the amount of antioxidant utilized is typically about 5 parts by weight or less, or about 1 part by weight or less, based on 100 parts by weight of the ionomer resin (dipolymer and terpolymer). Masterbatch compositions are adjusted up or down depending on what will be added thereto.

Examples of the ultraviolet ray absorber include benzotriazole-based ultraviolet ray absorbers, such as 2-(5-methyl-2-hydroxyphenyl)benzotriazole, 2-[2-hydroxy-3,5-bis(α,α′-dimethylbenzyl)phenyl]-2H-benzotriazole, 2-(3,5-di-t-butyl-2-hydroxyphenyl)benzotriazole, 2-(3-t-butyl-5-methyl-2-hydroxyphenyl)-5-chlorobenzotriazole, 2-(3,5-di-t-butyl-5-methyl-2-hydroxyphenyl)-5-chlorobenzotriazole and 2-(3,5-di-t-amyl-2-hydroxyphenyl)benzotriazole, 2-(2′-hydroxy-5′-t-octylphenyl)triazole; hindered amine-based ultraviolet ray absorbers, such as 2,2,6,6-tetramethyl-4-piperidyl benzoate, bis(2,2,6,6-tetramethyl-4-piperidyl)sebacate, bis(1,2,2,6,6-pentamethyl-4-piperidyl)-2-(3,5-di-t-butyl-4-hydroxybenzyl)-2-n-butylmalonate and 4-(3-(3,5-di-t-butyl-4-hydroxyphenyl)propionyloxy)-1-(2-(3-(3,5-di-t-butyl-4-hydroxyphenyl)propionyloxy)ethyl)-2,2,6,6-tetramethylpiperidine; benzoate-based ultraviolet ray absorbers, such as 2,4-di-t-butylphenyl-3,5-di-t-butyl-4-hydroxybenzoate and hexadecyl-3,5-di-t-butyl-4-hydroxybenzoate; and the like.

These ultraviolet ray absorbers can be used solely or in combination of two or more thereof. In the final resin composition, the amount of ultraviolet ray absorber utilized is typically about 10 ppm by weight or more, or about 100 ppm by weight or more, based on the weight of the ionomer resin. In addition, the amount of ultraviolet ray absorber utilized is typically about 50,000 ppm or less, or about 10,000 ppm or less, based on the weight of the ionomer resin.

In some embodiments, it is also possible to use two or more types of UV absorbers in combination.

In other embodiments, no UV absorber is added, or the compositions and masterbatches are substantially UV absorber additive free.

Examples of the photostabilizer include hindered amine-based materials, such as “ADEKA STAB LA-57” (a trade name) manufactured by Adeka Corporation, and “TINUVIN 622” (a trade name) manufactured by Ciba Specialty Chemicals Inc.

When a laminated glass is prepared by incorporating a heat-shielding fine particle or a heat-shielding compound as the heat-shielding material into the interlayer of the present invention to give a heat-shielding function to the laminate, a transmittance at a wavelength of 1,500 nm can be regulated to about 50% or less, or the TDS value (calculated from ISO 13837:2008) can be regulated to less than about 43%.

Examples of the heat-shielding fine particle include a metal-doped indium oxide, such as tin-doped indium oxide (ITO), a metal-doped tin oxide, such as antimony-doped tin oxide (ATO), a metal-doped zinc oxide, such as aluminum-doped zinc oxide (AZO), a metal element composite tungsten oxide represented by a general formula: MₘWOₙ (M represents a metal element; m is about 0.01 or more and about 1.0 or less; and n is about 2.2 or more and about 3.0 or less), zinc antimonate (ZnSb₂O₅), lanthanum hexaboride, and the like. Of those, ITO, ATO, and a metal element composite tungsten oxide are preferred, and a metal element composite tungsten oxide is more preferred. Examples of the metal element represented by M in the metal element composite tungsten oxide include Cs, Tl, Rb, Na, K, and the like, and in particular, Cs is preferred. From the viewpoint of heat shielding properties, m is preferably about 0.2 or more, or about 0.3 or more, and it is preferably about 0.5 or less, or about 0.4 or less.

From the viewpoint of transparency of the ultimate laminate, an average particle diameter of the heat shielding fine particle is preferably about 100 nm or less, or about 50 nm or less. It is to be noted that the average particle diameter of the heat shielding particle as referred to herein means one measured by a laser diffraction instrument.

In the final resin composition, a content of the heat shielding fine particle is preferably about 0.001% by weight or more, or about 0.05% by weight or more, or about 0.1% by weight or more, or about 0.2% by weight or more relative to the weight of the ionomer resin. In addition, the content of the heat shielding fine particle is preferably about 5% by weight or less, or about 3% by weight or less, or about 1% by weight or less, or about 0.5% by weight or less.

Examples of the heat shielding compound include phthalocyanine compounds, naphthalocyanine compounds, and the like. From the viewpoint of further improving the heat shielding properties, it is preferred that the heat shielding compound contains a metal. Examples of the metal include Na, K, Li, Cu, Zn, Fe, Co, Ni, Ru, Rh, Pd, Pt, Mn, Sn, V, Ca, Al, and the like, with Ni being especially preferred.

A content of the heat shielding compound is preferably about 0.001% by weight or more, or about 0.005% by weight or more, or about 0.01% by weight or more, based on the weight of the ionomer resin. In addition, the content of the heat shielding compound is preferably about 1% by weight or less, or about 0.5% by weight or less.

### Production of Recycle Material-Containing Compositions and Masterbatches

In one embodiment, recycle material (polymeric material that contains at least one dialkoxysilane adhesion promoter and which has been recovered from a previously produced polymeric material) can be fed into an extrusion process along with one or more other resins, preferably including virgin and/or fresh resin. Additional additives can also be included during the extrusion process alongside the recycle material. The recycle material may contain additives in addition to the at least one dialkoxysilane adhesion promoter, depending on the origin of the recycle material and the purpose of its first use. The physical size and dimensions of the recycle resin may require an additional processing step to facilitate it being ‘fed’ back into an extrusion process for blending. Additionally, reducing the size and optimizing the physical form of the recycle material will improve the uniformity of the re-processed resin, and for example minimize any optical non-uniformities in a finished film/sheet and resulting glass laminate. Alternatively, intensive extrusion compounding can be utilized to uniformly blend out nonuniformities/inhomogeneities, but in doing so care must be taken as this can contribute to the creation of additional resin degradation, often manifesting itself as increased yellowness and degraded resin (e.g. ‘black specks’). If the form of the recycle material requires a size-reduction step, various means exist to accomplish this step. Rotary cutting, mechanical chopping, slicing, shearing or other size reducing techniques may be used to prepare the recycle material for refeeding/introduction back into the process. Suitably sized recycle material particles, while generally not limited, can range in size from about 0.1 mm, or from about 0.2 mm, to about 5 mm, or to about 4 mm, or to about 2 mm, or to about 1 mm. Such particles can be measured by an optical microscope with a stage micrometer. Particles up to 1 mm can be measured using a stage micrometer of 1 mm with divisions of 0.01 mm. Particles greater than 1 mm can be measured using a stage micrometer of 25 mm with divisions of 0.05 mm. For the diameter, or in the case of oblong or irregularly-shaped particles, the largest dimension of 20 particles randomly selected from the resin can be measured and the average of 20 particles used to characterize the general particle size. For example, cryogenic grinding can be used to reduce the ionomer resin materials from their larger form to a nominal average particle size of about 4 mm down to about an average particle size ranging from about 0.1 mm to about 0.5 mm particle size. Also, these particles are fractured during the milling process and are of irregular shape. Cryogenic grinding processes are generally well known to those of ordinary skill in the relevant art, and typically involve the use of liquid nitrogen to chill resin materials in advance of the grinding/milling process. Once cooled, the recycle material proceeds through a mechanical mill. The use of liquid nitrogen to chill the recycle material enables more effective size reduction without undo heating and contribution to further polymer degradation.

In some cases, edge trim, for example, can be fed directly back into the extrusion process with proper equipment design (e.g. guide/pull rolls and screw design). Sometimes feed can be introduced into a ‘side feeder’ so that it is combined with the primary feed. Any means for returning recycle resin is within the scope of this patent art. As described above this recycled material may comprise one or more additives. The first recycled material can be a first ionomer resin.

These ionomer resin particles can also be prepared by other conventions means, for example, via underwater melt cutting. The pellets thus created are generally have a diameter or cross-section of 0.5 to 5 mm. Other methods well known to those of ordinary skill in the relevant art may be used for formulation and blending prior to a melting process generally achieved in an extrusion process.

The present invention also optionally uses at least one of the following:
second granules of a second recycle material, which comprises additives, and may also be an ionomer herein referred to as a second ionomer resin; and
first and/or second pellets of a third resin and/or fourth resin and optionally one or more additives, which are herein referred to as third ionomer resin and fourth ionomer resin.

“Fresh” (i.e., not recycled) additives can also be present in the third and fourth resins.

Once these materials are present/prepared, the first granules are coextruded using an extruder with one or more of the second granules, first pellets and second pellets, and optionally with one or more fresh additives, under conditions to melt and intimately mix the materials to produce a melt. The melt thus produced is then shaped into a film or sheet of a substantially continuous thickness in the longitudinal direction up to about 2.5 mm.

The ionomer resin can be a combination of virgin material and recycle material. In one embodiment, the ionomer resin is from about 5 wt % to about 30 wt %, or to about 25 wt %, to about 20 wt %, to about 15 wt %, or to about 10 wt %, recycle ionomer resin based on the total ionomer resin weight. In another embodiment, the ionomer resin is from about 10 wt % to about 30 wt %, or to about 25 wt %, to about 20 wt %, or to about 15 wt %, recycle ionomer resin based on the total ionomer resin weight. In another embodiment, the ionomer resin is from about 15 wt % to about 30 wt %, or to about 25 wt %, to about 20 wt %, recycle ionomer resin based on the total ionomer resin weight. In another embodiment, the ionomer resin is is from about 20 wt % to about 30 wt %, or to about 25 wt %, based on the combined weight of (i)+(ii). In another embodiment, the ionomer resin is from about 25 wt % to about 30 wt %, recycle ionomer resin based on the total ionomer resin weight.

### Production of Resin Compositions and Masterbatches

The resin compositions of the present invention can be produced as melt blends by feeding the various components into an extruder and intimately mixing the components under melt conditions for the ionomer resins to produce a substantially uniform mixture that can ultimately be formed into the final shape, for example, by melt extrusion or molding.

As would be recognized by those of ordinary skill in the relevant art, in melt blending, attention must be given to ensure mixing is intense enough to blend the dialkoxysilane into the resin to a sufficient degree of uniformity. Generally this high degree of mixing via extrusion compounding is performed by creating enough shear and residence time in the extruder. Care must also be taken to avoid undesirable results such as localized high concentrations of dialkoxysilane, decomposition of the dialkoxysilane and/or either one or both of the dipolymer and terpolymer due to high temperatures, etc.. Formation of discolored resin, gel or degraded product (e.g. black specks) can be avoided by choice of the correct process equipment and process conditions, and is within the skill of those of ordinary skill in the relevant art.

For example, it is well understood that the extent of hydrolysis of the dialkoxysilane will be heightened with undue exposure to moisture and at extended time, perhaps requiring further consideration for controlling extraneous moisture contact. Blanketing with dry-air or nitrogen might be necessary, for example, to maintain a desired minimal degree of hydrolysis of the silane.

In one embodiment of a composition in accordance with the present invention, it is a particulate composition comprising the recycle material and one or both of the dipolymer and terpolymer resin (ionomer resin) all in particulate form.

Desirably, this particulate composition can be prepared by physically mixing the ionomer resin particles and recycle particles under non-softening conditions for the ionomer resin and the recycle material, in other words, where the ionomer resin and recycle material does not melt or soften to the extent that it significantly agglomerates or otherwise loses its original particulate form.

The size of the ionomer resin particles, both for the dipolymer and the terpolymer, is not particularly limited. Suitably sized particles for preparing the final and masterbatch compositions can preferably range in size from about 0.1 mm, or from about 0.2 mm, to about 5 mm, or to about 4 mm, or to about 2 mm, or to about 1 mm. Such particles can be measured by an optical microscope with a stage micrometer. Particles up to 1 mm can be measured using a stage micrometer of 1 mm with divisions of 0.01 mm. Particles greater than 1 mm can be measured using a stage micrometer of 25 mm with divisions of 0.05 mm. For the diameter, or in the case of oblong or irregularly-shaped particles, the largest dimension of 20 particles randomly selected from the resin can be measured and the average of 20 particles used to characterize the general particle size.

In one embodiment, the particles for preparing the invention compositions and masterbatches are reduced from nominal pellet size, for example, by cryogenic grinding. For example, cryogenic grinding can be used to reduce the ionomer resin pellets from a nominal average particle size of about 4 mm diameter down to about average particle size ranging from about 0.1 mm to about 0.5 mm particle size. Reducing the particle size in this manner increases the particle surface area relative to the particle weight. Also, these particles are fractured during the milling process and are of irregular shape and this can further increase the surface area relative to particle weight as compared with nominally spherical ionomer resin pellet shapes. Cryogenic grinding processes are generally well known to those of ordinary skill in the relevant art, and typically involve the use of liquid nitrogen to chill pellets in advance of the grinding/milling process. Once cooled, the pellets proceed through a mechanical mill. The use of liquid nitrogen to chill the pellets enables more effective size reduction without undo heating and polymer degradation.

These ionomer resin particles can also be prepared by other conventions means, for example, via underwater melt cutting (for example, “micropellets” having an average diameter of about 0.5 to about 1.5 mm) or other methods well known to those of ordinary skill in the relevant art.

The dialkoxysilane additive is preferably present in the final resin composition in an amount of from about 50, or from about 100, or from about 250, or from about 500, or from about 750, to about 5000, or to about 4000, or to about 2000, or to about 1500, or to about 1250, parts per million by weight based on the total weight of the composition.

The dialkoxysilane additive is added to the compositions of the invention in whole or in part, or in whole, as “recycle material”. If in part, additional dialkoxysilane additive can be added with fresh or virgin resin, etc. The recycle material preferably comprises at least one of the dipolymer and terpolymer in addition to the dialkoxysilane additive.

In one embodiment, in the invention compositions, films, interlayers, etc., the weight ratio of virgin or fresh alkali metal-neutralized ethylene acid copolymer ionomer resin (e.g., dipolymer, terpolymer) to recycle material (w/w ionomer resin/recycle material), based on total weight of ionomer resin+recycle material, is not particularly limited. In one embodiment, the weight ratio of virgin/fresh ionomer resin to recycle material (w/w ionomer resin/recycle material) in a given composition, masterbatch, film, etc., based on total weight of ionomer resin+recycle material, is 0.1/99.9 to 99.9/0.1, inclusive of 0.5/99.5-99.5/0.5, 1/99-99/1, 3/97-97/3, 5/95-95/5, 10/90-90/10, 15/85-85/15, 20/80-80/20, 25/75-75/25, 30/70-70/30, 35/65-65/35, 40/60-60/40, 45/55-55/45, and 50/50. Preferred ratios are 99.5/0.5-70/30. For clarity, and as an example, a 70/30 ratio is provided by a 100 g composition containing 70 g fresh or virgin dipolymer and 30 g recycle material. A 112 gram composition containing 88 grams of virgin or fresh ionomer and 24 grams of recycle material has a ratio of 78.6/21.4.

The previously produced material from which recycle material comes can be waste material from a process used to make it, i.e., seconds, trimmings and the like. This material generally contains not only polymer(s) but also one or more additives. Therefore, when this polymeric material containing additives is recycled, the additives are also considered “recycled”. Recovered polymeric material can also be obtained from down-stream manufacturing operations, such as trims being derived from the conversion process of film and sheeting being fabricated into glass laminates. Additionally, it is possible that polymeric materials collected can be reprocessed to filter out contaminates through a secondary extrusion process to create material suitable for use.

Once recycle material containing at least one dialkoxysilane is obtained, it can be fed into the processes used to make the invention final compositions, masterbatches, etc., along with other resins, including virgin/fresh resin. Additional additives might also be included during the processing alongside the recycle material. The recycle material generally will contain one or more additives in addition to dialkoxysilanes, especially if this material had been previously extruded for the purpose of creating, e.g., an interlayer film/sheeting product.

The physical size and dimensions of the recycle material may require some additional processing steps to facilitate it being ‘fed’ into a process for blending, mixing, extruding, etc. This is generally the case, especially where the recycle material comes from the operation at hand, which for example is the extrusion formation of a film, sheet, or laminate, and the recycle material is other than an edge trimming, of the sheet being produced. Additionally, reducing the size and optimizing the physical form of the recycle material will improve the uniformity of the re-processed resin and minimize any optical non-uniformities in the finished film/sheet and resulting glass laminate when used for this purpose. This is valid whether the recycle is fed at 100% loading or with virgin ionomer resin or other resins and additives. Alternatively, intensive extrusion compounding can be utilized to uniformly blend out inhomogeneities, but this can also contribute to the creation of additional resin degradation, often manifesting itself as increased yellowness and degraded resin (e.g. ‘black specks’).

If the form of the recycle material requires a size-reduction step, various means exist to accomplish this step. Rotary cutting, mechanical chopping, slicing, shearing or other size reducing techniques may be used to prepare the recycle material for refeeding/introduction back into the process. Suitably sized ionomer resin recycle particles range in size from about 0.1 mm, or from about 0.2 mm, to about 5 mm, or to about 4 mm, or to about 2 mm, or to about 1 mm. Such particles can be measured by an optical microscope with a stage micrometer. Particles up to 1 mm can be measured using a stage micrometer of 1 mm with divisions of 0.01 mm. Particles greater than 1 mm can be measured using a stage micrometer of 25 mm with divisions of 0.05 mm. For the diameter, or in the case of oblong or irregularly-shaped particles, the largest dimension of 20 particles randomly selected from the resin can be measured and the average of 20 particles used to characterize the general particle size. For example, cryogenic grinding can be used to reduce the ionomer resin materials from their larger form to a nominal average particle size of about 4 mm down to about an average particle size ranging from about 0.1 mm to about 0.5 mm particle size. Also, these particles are fractured during the milling process and are of irregular shape. Cryogenic grinding processes are generally well known to those of ordinary skill in the relevant art, and typically involve the use of liquid nitrogen to chill resin materials in advance of the grinding/milling process. Once cooled, the recycle resin materials proceed through a mechanical mill. The use of liquid nitrogen to chill the resin materials enables more effective size reduction without undo heating and contribution to further polymer degradation.

In some cases, edge trim recycle material, for example, can be fed directly back into the extrusion process using proper equipment design well within the skill of the ordinary artisan (e.g. guide/pull rolls and screw design). For example, edge trim can be introduced into a ‘side feeder’ so that it is combined with a primary feed. Any means for returning recycle material is within the scope of the invention. As described above, this recycle material may comprise, in addition to one or more dialkoxysilanes, one or more additives, such as those described above.

Additional additives if present can be mixed as part of the masterbatch, or can be added in the preparation of the final resin composition via conventional means as would be recognized by persons of ordinary skill in the relevant art.

In one embodiment the recycle material has a content of at least one of the dipolymer, terpolymer, dialkoxysilane, and other additives that is substantially the same as their content in the composition, film, etc., being prepared, and preferably has a content of all of the dipolymer, terpolymer, dialkoysilane, and other additives that is substantially the same as their content in the composition, masterbatch, film, etc., being prepared. In another embodiment the recycle material has a content of the dipolymer, terpolymer, and dialkoysilane such that at least one such content is different from its content in a final composition being prepared. In preferred embodiments, the final composition contains recycle material, dipolymer or terpolymer (not both), and one or more optional additives. In another preferred embodiment, any dipolymer and/or terpolymer present/added/used, other than that in the recycle material (if any), is in virgin or fresh form.

In preferred embodiments, the recycle material comprises, consists essentially of, or consists of one or more dialkoysilanes, dipolymer or terpolymer (not both), and one or more optional additives. In another preferred embodiment, any dipolymer and/or terpolymer present/added/used, other than that in the recycle material (if any), is in virgin or fresh form.

### Sheets/Films/Interlayers

Sheets of the ionomer resin compositions of the present invention can be prepared by conventional melt extrusion or melt molding processes suitable for making interlayers for glass laminates. Such processes are well-known to those of ordinary skill in the relevant art, as exemplified by the previously incorporated publications.

The sheets can be monolayer or multilayer sheets. For example, multilayer sheets can be formed having a functional core layer sandwiched between two exterior layers and other optional interior layers. In one embodiment, at least one (or both) of the exterior layers of the multilayer interlayer is a sheet of the ionomer resin composition in accordance with the present invention.

As one example of a functional core layer there can be mentioned an acoustic damping layer, such as a polystyrene copolymer intermediate film (see JP2007-91491A), a polyvinyl acetal layer (see US2013/0183507A1, U.S. Pat. No. 8,741,439B2, JP2012-214305A and U.S. Pat. No. 8,883,317B2), a viscoelastic acrylic layer (see U.S. Pat. No. 7,121,380B2), a layer containing a copolymer of styrene and a rubber-based resin monomer (see JP2009-256128A), a layer containing a polyolefin (see US2012/0204940A1), a layer containing an ethylene/vinyl acetate polymer (see WO2015/013242A1), a layer containing an ethylene acid copolymer (see WO2015/085165A1).

In one specific embodiment, the intermediate layer is thermoplastic elastomer resin, such as disclosed in WO2016/076336A1, WO2016/076337A1, WO2016/076338A1 WO2016/076339A1, WO2016/076340A1 and US2017/0320297A1. In a more specific embodiment, the thermoplastic elastomer resin is a hydrogenated product of a block copolymer having:
(i) an aromatic vinyl polymer block (a) containing about 60 mol % or more of an aromatic vinyl monomer unit, based on the aromatic vinyl polymer block, and
(ii) an aliphatic unsaturated polymer block (b) containing about 60 mol % or more of a conjugated diene monomer unit, based on the aliphatic unsaturated polymer block,
wherein the aliphatic unsaturated polymer block (b) contains about 50 mol % or more in total of an isoprene unit and a butadiene unit as the conjugated diene monomer unit, and
wherein the amount of residual carbon-carbon double bonds the aliphatic unsaturated polymer block derived from conjugated diene monomer units is from about 2 to about 40 mol %.

Further, the interlayer as a whole can be symmetric having a substantially consistent thickness, or can be asymmetric wherein a portion of the interlayer has a thickness greater than another portion (for example, partial or full “wedge”, as discussed in US2017/0320297A1 and US2018/0117883A1. Further, the laminate can be substantially clear or having coloring in all or a portion (for example, “shadeband” as discussed in US2017/0320297A1 and US2018/0117883A1.

In a symmetric construction, the interlayer preferably possesses a total film thickness of about 320 μm or more, or about 420 μm or more. In addition, the total film thickness should be about 1250 μm or less, or about 1,000 μm or less.

In an asymmetric construction such as a wedge, the thinner portion of the interlayer should possess the thicknesses of a symmetric construction, while the thickness of the thick portion will depend on various parameters such as wedge angle. In one embodiment of a wedge-shaped interlayer, the thicker edge has a thickness of about 1850 μm or less, or about 1600 μm or less, or about 1520 μm or less, or about 1330 μm or less, or about 1140 μm or less; and the thinner edge has a thickness of about 600 μm or more, or about 700 μm or more, or about 760 μm or more.

In addition, a concave and convex structure, such as an embossing, can be formed on the surface of the interlayer of the present invention by conventionally known methods for assistance in deairing in laminate production. The shape of the embossing is not particularly limited, and those which are conventionally known can be adopted.

In one embodiment, at least one surface (and preferably both surfaces) of the interlayer for a laminated glass is shaped. By shaping at least one surface of the interlayer for a laminated glass, in the case where a laminated glass is produced, an air bubble present at an interface between the interlayer for a laminated glass and a glass easily escapes to the outside of the laminated glass, and thus, the appearance of the laminated glass can be made favorable. It is preferred to shape at least one surface of the interlayer for a laminated glass by an embossing roll method. By shaping the surface of the interlayer for a laminated glass, a concave portion and/or a convex portion are/is formed on the surface of the interlayer for a laminated glass.

An embossing roll to be used in the embossing roll method can be produced, for example, by using an engraving mill (mother mill) having a desired concave-convex pattern and transferring the concave-convex pattern to the surface of a metal roll. Further, an embossing roll can also be produced using laser etching. Further, after forming a fine concave-convex pattern on the surface of a metal roll as described above, the surface with the fine concave-convex pattern is subjected to a blast treatment using an abrasive material such as aluminum oxide, silicon oxide, or glass beads, whereby a finer concave-convex pattern can also be formed.

Further, the embossing roll to be used in the embossing roll method is preferably subjected to a release treatment. In the case where an embossing roll which is not subjected to a release treatment is used, it becomes difficult to release the interlayer for a laminated glass from the embossing roll. Examples of a method for the release treatment include known methods such as a silicone treatment, a Teflon (registered trademark) treatment, and a plasma treatment.

The depth of the concave portion and/or the height of the convex portion (hereinafter sometimes referred to as “the height of the embossed portion”) of the surface of the interlayer for a laminated glass shaped by an embossing roll method or the like are/is typically about 5 μm or more, or about 10 μm or more, or about 20 μm or more. The height of the embossed portion is typically about 150 μm or less, or about 100 μm or less, or about 80 μm or less.

In the invention, the height of the embossed portion refers to a maximum height roughness (Rz) defined in JIS B 0601 (2001). The height of the embossed portion can be measured by, for example, utilizing the confocal principle of a laser microscope or the like. Incidentally, the height of the embossed portion, that is, the depth of the concave portion or the height of the convex portion may vary within a range that does not depart from the gist of the invention.

Examples of the form of the shape imparted by an embossing roll method or the like include a lattice, an oblique lattice, an oblique ellipse, an ellipse, an oblique groove, and a groove. The inclination angle of such form is typically from about 10° to about 80° with respect to the film flow direction (MD direction). Further, the shaping pattern may be a regular pattern or an irregular pattern such as a random matte pattern, or a pattern such as disclosed in U.S. Pat. No. 7,351,468B2.

The shaping by an embossing roll method or the like may be performed on one surface of the interlayer for a laminated glass, or may be performed on both surfaces, but is more typically performed on both surfaces.

### Laminates

It is possible to produce laminates of the present invention by conventionally known methods. Examples thereof include using a vacuum laminator, using a vacuum bag, using a vacuum ring, using a nip roll, and the like. In addition, a method can be used in which, after temporary contact bonding, the resultant laminate is put into an autoclave for final bonding.

In the case of using a vacuum laminator, for example, a known instrument which is used for production of a solar cell can be used, and the assembly is laminated under a reduced pressure of about 1×10⁻⁶ MPa or more and about 3×10⁻² MPa or less at a temperature of about 100° C. or higher, or about 130° C. or higher, and about 200° C. or lower, or about 170° C. or lower. The method of using a vacuum bag or a vacuum ring is, for example, described in EP1235683A1 (CA2388107A1) and, for example, the assembly is laminated under a pressure of about 2×10⁻² MPa at about 130° C. or higher and about 145° C. or lower.

In the case of using a nip roll, for example, there is exemplified a method in which after conducting first temporary contact bonding at a temperature of a flow starting temperature of the skin resin or lower, temporary contact bonding is further conducted under a condition close to the flow starting temperature. Specifically, for example, there is exemplified a method in which the assembly is heated at about 30° C. or higher and about 100° C. or lower by an infrared heater or the like, then deaerated by a roll, and further heated at about 50° C. or higher and about 150° C. or lower, followed by conducting contact bonding by a roll to achieve bonding or temporary bonding.

Though the autoclave process which is supplementarily conducted after the temporary contact bonding is variable depending upon the thickness or constitution of a module, it is, for example, carried out under a pressure of about 1 MPa or more and about 15 MPa or less at a temperature of about 120° C. or higher and about 160° C. or lower for about 0.5 hours or more and about 2 hours or less.

Well-known “no-autoclave” processes may alternatively be used to process laminates.

Advantageously, the glass to be used for preparing a laminated glass is not particularly limited. Inorganic glasses, such as a float sheet glass, a polished sheet glass, a figured glass, a wired sheet glass, a heat-ray absorbing glass, and conventionally known organic glasses, such as polymethyl methacrylate and polycarbonate, and the like can be used. These glasses may be any of colorless, colored, transparent, or non-transparent glasses. These glasses may be used solely, or may be used in combination of two or more thereof.

As used in the present invention, the laminates are cooled after they are produced. An autoclave is generally used to thermally process glass/interlayer assemblies into finished laminated glass, however there are also non-autoclave processes that are also utilized. Regardless of the specific process employed, all use a heat cycle that increases the temperature of the assembly above the melting point of the ionomer interlayer and thereby the cooling process to bring the laminates closer to ambient temperature and this step may be done at different cooling rates. They may be cooled quickly, at a rate of about 2 to 20 degrees C./minute, or more slowly by allowing the laminate to reach room temperature in a sub-optimum cooling process, applied at a rate of about 0.1 degrees C./minute, or anything in-between. If the cooling rate is too fast and/or is conducted in a non-uniform manner, there is a heightened probability of thermal shock and breakage of glass.

On the other hand, if the glass laminates cool too slowly (generally below 1 degrees C./minute), additional crystallization phenomena can occur, with the potential to increase the resultant haze of the finished article. Crystallinity is an inherent property of these types of ethylene-acid derived ionomers. Guidelines are provided for processing these materials (c.f. Kuraray Lamination Guidelines for Processing SentryGlas®—available from Kuraray America Inc.). There are several origins of cooling rate limitations when processing laminated glass: 1). Insufficiency of equipment design or operation which physically limits the removal of heat from the laminated glass, thereby reducing cooling rate to sub-optimum values. 2). Very thick glass and/or interlayer and multi-ply laminate constructions, where thermal conduction limits the absolute rate of cooling of the ionomer resin internal to the glass laminate, in spite of attempts to apply aggressive external cooling. 3). Placement of glass laminate within the autoclave or oven or thermal treatment means in such a way that different cooling rates occur due to changes in heat transfer (conduction and convection), and non-uniform temperature zones and differing degree of thermal radiation.

In practice, while not limiting of the embodiments herein, ‘quick’ cooling generally refers to cooling accomplished by using a maximal cooling rate setting on an available autoclave (e.g., United McGill—20 degrees C./min). The actual cooling rate within and inside the glass laminate where the actual resin/interlayer is, would be, by thermodynamics, less than the externally applied cooling rate. Thermocouples can be placed inside the interlayer within the glass laminate, allowing for direct measurement of the cooling rate. Generally, a rate of 10 C/min. to about 2 C/min. was obtained depending on actual temperature of the sample. Since the heat flow from the glass laminate will be a function of the difference in temperature between the laminate and the surrounding ‘cooling means’ (e.g., cooling air), the rate will generally be faster at higher temperatures and asymptotically become less as the glass laminate temperature becomes more similar to the temperature of the cooling means. Therefore, in practice it is difficult to state this as a single cooling rate value for quick cooling. However, for slow cooling the situation is different becasue thermal equilibrium is close to being achieved, and therefore the internal temperature ‘tracks’ closely with the external temperature, so that a cooling rate of 0.1 C/min. is both measured and stated as fairly uniform across that entire cooling range to ambient.

The laminated glass of the present invention can be suitably used for a windshield for automobile, a side glass for automobile, a sunroof for automobile, a rear glass for automobile, or a glass for head-up display; a building member for a window, a wall, a roof, a sunroof, a sound insulating wall, a display window, a balcony, a handrail wall, or the like; a partition glass member of a conference room; a solar panel; and the like. Further information on such uses can be found by reference to the previously incorporated publications.

The invention will be further understood from the following specific examples. However, it will be understood that these examples are not to be construed as limiting the scope of the present invention in any manner.

### Ionomer Sheet Preparation

Ionomer 1 and recycle material containing ionomer 1 and a dialkoxysilane silane S1, S2, or S3 are fed using a K-Tron feeder (Coperion GmbH) equipped with a calibrated pigtail type auger at about 5 to 7 lbs./hour into 18-mm diameter Liestritz twin-screw compounding extruder (screw speed set at 200 rpm) and extruded into polymer strands (two 6-mm hole die).

The polymer throughput is controlled by adjusting the screw speed to provide for a given throughput or residence time and resultant shear condition. The melt strand is drawn through a water batch containing ambient temperature demineralized water, the excess water is blown off with compressed air and the strand is fed into a rotating cutter (Conair) resulting in chopped strand pellets. These pellets are then dried overnight in a vacuum oven at 50° C. with a slight dry nitrogen purge. The pellets are then compression molded into nominal 0.76 mm thick sheets measuring 150-mm by 200-mm.

### Laminate Preparation Method

Glass laminates are prepared from the ionomer sheets by the following method. Annealed glass sheets (100×100×3 mm) are washed with a solution of trisodium phosphate (5 g/l) in de-ionized water at 50° C. for 5 min, and rinsed thoroughly with de-ionized water and dried. Three layers of ionomer sheets (about 0.76 mm thick each) are stacked together and placed between two lites of glass sheet (to yield an interlayer thickness of 2.28 mm).

The moisture level of the ionomer sheet is kept at or below 0.08% by weight by minimizing contact time to the room environment.

The moisture level of the ionomer sheet is measured using a coulometric Karl Fischer method (Metrohm Model 800) with a heating chamber temperature of 150° C. for the sample vials. The ionomer sheeting is cut into small pieces to fit into the sample vials weighing a total of 0.40 grams.

The pre-lamination assembly is then taped together with a piece of polyester tape in a couple locations to maintain relative positioning of each layer with the glass lites. A nylon fabric strip is placed around the periphery of the assembly to facilitate air removal from within the layers. The assembly is placed inside a nylon vacuum bag, sealed and then a connection is made to a vacuum pump. A vacuum is applied to allow substantial removal of air from within (air pressure inside the bag is reduced to below 50 millibar absolute). The bagged assembly is then heated in a convection air oven to 120° C. and held for 30 min. A cooling fan is then used to cool the assembly down to near room temperature and the assembly is disconnected from the vacuum source and the bag removed yielding a fully pre-pressed assembly of glass and interlayer.

The assembly is then placed into an air autoclave and the temperature and pressure are increased from ambient to 135° C. at 13.8 bar over 15 min. This temperature and pressure is held for 30 min and then the temperature is decreased to 40° C. at a cooling of about 2.5° C./min whereby the pressure is then dropped back to ambient (over 15 min) and the final laminates are removed from the autoclave.

The glass used was soda-lime glass, standard annealed (obtained from Guardian Industries, Inc., Galax VA, USA).

Resins utilized: See Table 1.

### Ionomer Sheet Preparation

The ionomer resins were combined when needed by dry blending and any additives (if present) were fed using a K-Tron feeder (Coperion GmbH) equipped with a calibrated pigtail type auger at about 5 to 7 lbs./hour into 18-mm diameter Liestritz twin-screw compounding extruder (screw speed set at 400 rpm) with zone temperatures being set to control at 210 C barrel temperature and the melt temperature at the die falling in the range of 205 to 225 C. The polymer was extruded into strands (two 6-mm hole die).

The polymer throughput was controlled by a combination of the feed rate and the extruder screw speed to provide for a given throughput or residence time and resultant shear condition. As the melt strand exited the die, it was drawn through a water bath containing demineralized water at ambient temperature, the excess water was blown off with compressed air and the strand was fed into a rotating cutter (Conair) resulting in chopped strand pellets (nominal length of 4-mm). These pellets were then dried overnight in a vacuum oven at 50° C. with a slight dry nitrogen purge. The pellets were then compression molded into nominal 0.76 mm thick plaques measuring 150-mm by 200-mm. These plaques were then maintained in a dry atmosphere prior to preparation into laminates.

### Laminate Preparation Method

Glass laminates were prepared from each of the ionomer sheets by the following method. Annealed glass sheets (100×100×3 mm) were washed with a solution of trisodium phosphate (5 g/l) in de-ionized water at 50° C. for 5 min, then rinsed thoroughly with de-ionized water and dried. Three layers of each respective ionomer plaques (about 0.76 mm thick each) were stacked together and placed between two lites of glass sheet (to yield an interlayer thickness of 2.28 mm).

The moisture level of the ionomer sheet was kept at or below 0.08% by weight by minimizing contact time to the room environment (about 35% RH) or was exposed for a period of 10 days (samples placed in an Espec Humidity chamber—Model LHU-113) at the temperature and humidity levels as indicated in the following examples.

The moisture level of the ionomer sheet was measured using a coulometric Karl Fischer method (Metrohm Model 800) with a heating chamber temperature of 150° C. for the sample vials. The ionomer sheeting was cut into small pieces to fit into the sample vials weighing a total of 0.40 grams.

The pre-lamination assembly was then taped together with a piece of polyester tape in a couple locations to maintain relative positioning of each layer with the glass lites. A nylon fabric strip was placed around the periphery of the assembly to facilitate air removal from within the layers. The assembly was placed inside a nylon vacuum bag, sealed and then a connection was made to a vacuum pump. A vacuum was applied to allow substantial removal of air from within (air pressure inside the bag was reduced to below 50 millibar absolute). The bagged assembly was then heated in a convection air oven to 120° C. and held for 30 min. A cooling fan was then used to cool the assembly down to near room temperature and the assembly was disconnected from the vacuum source and the bag removed yielding a fully pre-pressed assembly of glass and interlayer.

The assembly was then placed into an air autoclave and the temperature and pressure were increased from ambient to 135° C. at 13.8 bar over 15 min. This temperature and pressure was held for 30 min and then the temperature was decreased to 40° C. at a cooling of about 2.5° C./min whereby the pressure was then dropped back to ambient (over 15 min) and the final laminates were removed from the autoclave.

After the autoclave processing, the finished laminates were reheated in an air-circulating oven controlled at a temperature of 120° C.+/−2° C. and held for 2 to 3 hours to reach thermal equilibrium. Then, laminates were either slowly cooled at 0.1° C./min. to ambient temperature (˜23° C.), or quickly cooled (Quick) by removing the laminates from the 120° C. and cooling rapidly by forcing room temperature air across the face of each laminate by use of a large floor fan. A thermocouple placed within the ionomer interlayer and near the center of the laminate was used to determine the actual cooling rate curve of the sample. The temperature dropped from 120° C. to about 85° C. in 7 minutes and from 85° C. to 60° C. in 10 minutes and from 60° C. to 30° C. in 18 minutes and another 10 minutes brought the internal laminate temperature back to near room temperature. After these thermal cooling rate treatments of ‘Quick’ and 0.1° C./min (Slow) cooling, the optical measurements presented in Table 3 was developed.

### Haze and YI Measurements

The laminates were thoroughly cleaned using WINDEX glass cleaner (S.C. Johnson & Son, Inc.) and lintless cloths and were inspected to ensure that they were free of bubbles and other defects which might otherwise interfere with making valid optical measurements. The laminates were then evaluated by means of a Haze-gard Plus hazemeter (Byk-Gardner) to obtain a measurement of percent haze. The measurement of haze followed the practice outlined in American National Standard (ANSI Z26.1-1966) “Safety Code for Safety Glazing Materials for Glazing Motor Vehicles Operating on Land Highways”. Test section 5.17 and 5.18 along with FIGS. 5 and 6 in such standard detail the appropriate method and instrumental setup to measure the haze level of a glazing material. The Hazegard Plus hazemeter meets the proper criteria for this standard was used in all forthcoming measurements. Haze standards which are traceable to the National Bureau of Standards (now NIST) were used to ensure that the instrument was well-calibrated and operating properly. Color, when measured, was made on a Hunterlab ULTRASCAN XE (Hunter Associates Laboratory, Inc., Reston, Va.) using 10 degree/D65 illuminant/observer. Yellowness index (YI) was calculated by ASTM E313-05, using a 2-degree observer and Illuminant C (2 degree.).

### Peel Adhesion Measurements

To allow for measurement of peel adhesion, some samples were prepared as above with the following exceptions.

Annealed glass was scribed, cut into 100 mm×200 mm rectangles and then washed per the procedure described earlier. Thin polyester tape (25 um thickness×25 mm width) with silicone adhesive was applied to the glass surface on the ‘side-of-interest’ (air or tin-side) in two parallel strips providing a uniform 25 mm wide bonding area in between. This procedure allows for the creation of a very well-defined bonding area without the need to cut through the polymer layer to create a peel strip as is conventionally performed in standard peel adhesion methodologies. Over top of the interlayer specimen, a thin 4-mil sheet of FEP film was placed over the plastic sheeting prior to placing the second piece of glass on top to provide a relatively flat surface for the lamination step and to act as a release layer for removal of the top piece of glass. All lamination steps were then carried out as stated above. Afterwards, 90 degree angle peel adhesion measurements were made on a variety of samples produced by the process above via a mechanical testing device (INSTRON Model 1122, Instron Industrial Products, Norwood, MA USA). The peels were conducted at a crosshead speed of 1-cm/min. rate under standard laboratory conditions (nominal 23° C. and 50% RH). After peeling approximately 100-mm of the sample, demineralized water was applied to the glass and peel interface, so that the interface was now fully immersed into liquid water. The peel was allowed to continue until approximately another 100-mm of the sample was tested. Sufficient water was present to insure the sample was maintained in the ‘wet’ state during this final testing period. The data was collected via the computer software (INSTRON Bluehill III software, Instron Industrial Products, Norwood, MA USA) and an average force level was computed for the “50% RH” and the “wet-state” peel test sections.

TABLE 1
List of Polymers

| Resin Code | Polymer Type | Description |
|---|---|---|
| IO-1 | Sodium | partially neutralized ethylene acid dipolymer ionomer |
| | ionomer | obtained from Dow Chemical Co. (21.7% |
| | | methacrylic acid, Na 26% neutralized, MI = |
| | | 1.8 @190° C.) |
| IO-2 | Sodium | partially neutralized ethylene acid terpolymer |
| | ionomer | ionomer obtained from Dow Chemical Co. (21.3% |
| | | methacrylic acid, 3.7% i-butyl methacrylate, Na 25% |
| | | neutralized, MI = 2.5 @190° C.)) |
| IO-3 | Sodium | Recycle created from partially neutralized ethylene |
| | ionomer | acid dipolymer ionomer obtained from Dow |
| | recycle | Chemical Co. (21.7% methacrylic acid, Na 26% |
| | | neutralized, MI = 1.8 @190° C.) |
| IO-4 | Sodium | Recycle created from partially neutralized ethylene |
| | ionomer | acid terpolymer ionomer obtained from Dow |
| | recycle | Chemical Co. (21.3% methacrylic acid, 3.7% i-butyl |
| | | methacrylate, Na 25% neutralized, MI = 2.5 @190° |
| | | C.)); containing ~750 ppm 3- |
| | | glycidoxypropylmethyldiethoxysilane as formulated |
| | | and subsequently processed into sheeting by |
| | | extrusion processing. |
| IO-5 | Sodium | Recycle created from partially neutralized ethylene |
| | ionomer | acid dipolymer ionomer obtained from Dow |
| | recycle | Chemical Co. (21.7% methacrylic acid, Na 26% |
| | | neutralized, MI = 1.8 @190° C.) containing ~1000 |
| | | ppm 3-glycidoxypropylmethyldiethoxysilane as |
| | | formulated and subsequently processed into sheeting |
| | | by extrusion processing. |

TABLE 2
Peel Adhesion of Ionomers and Blends

| | | | | | Peel Adhesion | | | |
|---|---|---|---|---|---|---|---|---|
| | | | | | (N/cm) | | | |
| | | | | As-prepared | 50% RH | | Wet- | |
| | | | | sheet | Environment | | State | |
| | | Resin Blends (wt. %) | | moisture | Air- | Tin- | Air- | Tin- |
| Ex. | Ionomer | Comp. X | Comp. Y | (wt %) | side | side | side | side |
| CE-1 | IO-1 | | | 0.08% | 12.98 | 15.15 | 1.32 | 2.49 |
| CE-2 | IO-2 | | | 0.08% | 22.26 | 14.87 | 5.64 | 3.25 |
| | | IO-2 | IO-4 | | | | | |
| CE-3 | | 100 | 0 | 0.08% | 8.48 | 7.90 | 1.23 | 2.63 |
| EX-01 | | 75 | 25 | 0.08% | 12.23 | 10.01 | 1.75 | 3.15 |
| EX-02 | | 50 | 50 | 0.08% | 14.26 | 10.79 | 2.63 | 3.51 |
| EX-03 | | 25 | 75 | 0.08% | 17.34 | 10.60 | 1.80 | 3.42 |
| CE-4 | | 0 | 100 | 0.08% | 17.72 | 11.17 | 3.06 | 3.33 |
| | | IO-1 | IO-4 | | | | | |
| CE-5 | | 100 | 0 | 0.05% | 13.87 | 13.68 | 1.31 | 3.06 |
| EX-04 | | 90 | 10 | 0.05% | 17.72 | 15.79 | 1.40 | 3.33 |
| EX-05 | | 75 | 25 | 0.05% | 20.23 | 13.10 | 1.58 | 3.24 |
| EX-06 | | 50 | 50 | 0.05% | 22.15 | 16.37 | 2.45 | 3.06 |
| EX-07 | | 25 | 75 | 0.05% | 21.19 | 16.95 | 2.19 | 3.5 |
| CE-6 | | 0 | 100 | 0.05% | 25.43 | 17.34 | 3.15 | 4.03 |
| | | IO-1 | IO-5 | | | | | |
| EX-08 | | 75 | 25 | 0.05% | 15.69 | 14.03 | 1.51 | 3.14 |
| CE-7 | | 0 | 100 | 0.05% | 17.34 | 15.52 | 2.03 | 3.57 |

The peel adhesion data in provided in Table 2 demonstrates the surprising aspect of enhanced adhesion behavior above and beyond that exhibited by either of the virgin ionomer resins (IO-1 or IO-2). The addition of even low weight percentage (e.g. 25%) of a recycled ionomer resin (IO-4) having been previously modified by 3-glycidoxypropylmethyldiethoxysilane in these cases (e.g. EX-01 or EX-05). Retention of adhesion is maintained through reprocessing of said resin and is in general, the increase in adhesion is proportional to the addition percentage of the silane-modified recycle resin added.

In the subsequent tables of examples, a commensurate increase in haze with slow cooling was also apparent for all ionomer containing samples. It is well understood that ionomers of this family of compositions (ethylene-methacrylic acid copolymers and terpolymers as ionomers) possess some crystallinity and they also exhibit micro-phase-separation of polymer backbone and ionic clusters. These crystallites/ionic clusters then may cause visible light scattering (e.g. haze/lack of clarity) with the magnitude generally always increasing as the cooling rate decreases. During thermal processing of ionomer type interlayers into laminated glass form, general recommendations are to provide cooling from the ‘hot’ portion of the cycle (typically called ‘heat soak’ and at temperatures in the range of 105 C to 170 C) at a sufficient cooling rate to minimize the resulting haze formation due to the recrystallization and solidification process. As the ionomer interlayer cools from the melted state back to its ‘solid form’, the laminated glass is then stable and can be handled safely. Haze is an undesirable characteristic for glass laminates where high transparency is desired, therefore, faster cooling rates are also desirable. However, equipment limitations, adjustment of process settings and process conditions, differences in thermal heat transfer due to materials of construction and physical size/thickness, and so forth, will determine the actual rate of cooling that is typical or possible for glass laminates containing ionomer-based interlayers.

Table 3 shows the haze and YID data for various combinations of blends of the following components: a). a virgin dicarboxylic acid ionomer (IO-1), b). a virgin terionomer (IO-2), or each with their corresponding recycle resin forms, respectively IO-3 & IO-4. Normal and typical manufacturing operations would generally utilize a certain portion of the polymer resin that is extruded to be returned back into the process as recycle (internally derived). The compositional limits on the amount of recycle that would be appropriate to add would be related to the degree of impact on visible quality or to minimize any undesirable shifts in other performance parameters (e.g. tensile strength) that would result. Surprisingly, blends of the dicarboxylic acid (in either virgin resin and/or its corresponding recycle form) with the terpolymer (in either virgin resin and/or its corresponding recycle form) showed very good optical behavior with regard to haze and YID levels over the entire blend range. This would allow for complete flexibility in manufacturing to blend this resin family together with the finished product of such, providing acceptable optical consistency. Customers processing these blends could then expect uniform optical performance after laminating the sheet product comprising any blend ratio of said art even with differences in thermal cycles/cooling rates exhibited by their lamination process.

TABLE 3

| | Description | Cooling Rate | Haze | |
|---|---|---|---|---|
| EXAMPLE | (wt. %) | (C/min.) | (%) | YID |
| EX3-1 | IO-2 in IO-4 (25:75) | 0.1 | 3.53 | 0.47 |
| EX3-2 | IO-2 in IO-4 (50:50) | 0.1 | 3.41 | 0.26 |
| EX3-3 | IO-2 in IO-4 (75:25) | 0.1 | 3.38 | 0.01 |
| EX3-4 | IO-2 in IO-4 (25:75) | Quick | 0.58 | 0.11 |
| EX3-5 | IO-2 in IO-4 (50:50) | Quick | 0.54 | −0.09 |
| EX3-6 | IO-2 in IO-4 (75:25) | Quick | 0.58 | −0.41 |
| EX3-7 | IO-1 in IO-4 (25:75) | 0.1 | 4.47 | 0.79 |
| EX3-8 | IO-1 in IO-4 (50:50) | 0.1 | 4.69 | 0.75 |
| EX3-9 | IO-1 in IO-4 (75:25) | 0.1 | 4.09 | 0.56 |
| EX3-10 | IO-1 in IO-4 (25:75) | Quick | 0.48 | −0.04 |
| EX3-11 | IO-1 in IO-4 (50:50) | Quick | 0.60 | 0.14 |
| EX3-12 | IO-1 in IO-4 (75:25) | Quick | 0.68 | 0.07 |
| EX3-13 | IO-1/IO-3/IO-4 | 0.1 | 5.46 | 1.29 |
| | (33.3:33.3:33.3) | | | |
| EX3-14 | IO-1/IO-3/IO-4 | Quick | 0.78 | 0.47 |
| | (33.3:33.3:33.3) | | | |

From the foregoing information it has been shown that there are novel blends of ionomer resin that surprisingly provide acceptable optical properties for use in glass laminates. The examples of the subject art of various blend compositions are sufficiently similar to any of the individual virgin ionomer resin components to meet end-use optical quality expectations. It is desirable to have either complete or significant compositional latitude of blends of combinations of resins for flexibility in manufacturing of said ionomer interlayers possessing acceptable or desired optical properties (transparency, low haze and low yellowness (color)). Blends of a select sodium ionomer based on a dicarboxylic acid copolymer resin (ethylene/carboxylic acid) with a select sodium ionomer based on a terpolymer resin (ethylene/acrylate/carboxylic acid) have been shown to exhibit acceptable optical performance over their entire compositional range. Another sodium ionomer of a dicarboxylic acid copolymer resin exhibits very non-linear and unexpected yellowness when blended with either the select dicarboxylic acid ionomer or the select terpolymer ionomer resin or combinations thereof. Where embodiments using blends, mixtures, combinations, etc. of components are described herein all ratios of components are contemplated unless otherwise stated. For example, and without limitation, where a combination of di- and ter-polymer are used, e.g. (i) and (ii) above, weight ratios of 99.9/0.1-0.1/99.9 are contemplated as are all intervening ratios such as 90/10, 75/25, 60/40, 50/50, 40/60, 25/75, 10/90, etc., w/w (i)/(ii).

The above written description of the invention provides a manner and process of making and using it such that any person of ordinary skill in the relevant art is enabled to make and use the same, this enablement being provided in particular for the subject matter of the appended claims, which make up a part of the original description. This description is provided in the context of a particular application and its requirements. Various modifications to the embodiments will be readily apparent to those of ordinary skill in the relevant art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the invention may not show every benefit of the invention, considered broadly.

1. An ionomer resin composition comprising a blend of a dialkoxysilane adhesion promoter with an ionomer resin, wherein the ionomer resin is
(i) an at least partially sodium-neutralized ethylene acid dipolymer ionomer resin, or
(ii) an at least partially sodium-neutralized ethylene acid ester terpolymer ionomer resin, or
(iii) any combination of (i) and (ii),
and wherein at least a portion of the dialkoxysilane adhesion promotor and at least a portion of the ionomer resin is present in the form of a recycle material.

2. The composition as claimed in claim 1, wherein the ionomer resin comprises:
(i) an at least partially sodium-neutralized ethylene acid dipolymer ionomer resin consisting essentially of copolymerized units of ethylene and at least one α,β-unsaturated carboxylic acid, or
(ii) an at least partially sodium-neutralized ethylene acid terpolymer ionomer resin comprising copolymerized units of ethylene, at least one α,β-unsaturated carboxylic acid, and at least one α,β-unsaturated carboxylic acid ester, or
a combination of (i) and (ii).

3. The composition as claimed in claim 1, wherein said dialkoxysilane adhesion promoter is present in the ionomer resin composition in an amount ranging from about 50 to about 5000 parts per million by weight based on the weight of the ionomer resin.

4. The ionomer resin composition as claimed in claim 1, wherein the ionomer resin comprises virgin sodium-neutralized ethylene acid copolymer.

5. The ionomer resin composition as claimed in claim 1, wherein the ionomer resin comprises a combination of virgin material and recycle material.

6. The ionomer resin composition as claimed in claim 5, wherein the ionomer resin is from about 5 wt % to about 30 wt % recycle ionomer resin based on the total ionomer resin weight.

7. The ionomer resin composition as claimed in claim 5, wherein the ionomer resin is from about 5 wt % to about 25 wt % recycle ionomer resin based on the total ionomer resin weight.

8. The ionomer resin composition as claimed in claim 5, wherein the ionomer resin is from about 10 wt % to about 25 wt % recycle ionomer resin based on the total ionomer resin weight.

9. The ionomer resin composition as claimed in claim 4, wherein the virgin sodium-neutralized ethylene acid copolymer and the recycle material are intimately mixed.

10. The ionomer resin composition as claimed in claim 2,
wherein the dipolymer ionomer resin consists essentially of copolymerized units of:
(i) ethylene, and
(ii) from about 10 wt % to about 30 wt % of at least one α,β-unsaturated carboxylic acid having 3 to 10 carbon atoms,
wherein the weight percentages of the copolymerized units of the dipolymer ionomer resin are based on the total weight of the dipolymer ionomer resin and the sum of the weight percentages of the dipolymer ionomer resin's copolymerized units is 100 wt %, and wherein at least a portion of the dipolymer ionomer resin's carboxylic acid groups of the α,β-unsaturated carboxylic acid are neutralized to form an ionomer comprising carboxylate groups having sodium counterions, and
wherein the terpolymer ionomer resin consists essentially of copolymerized units of:
(i) ethylene,
(ii) from about 10 wt % to about 30 wt % of at least one α,β-unsaturated carboxylic acid having 3 to 10 carbon atoms,
(iii) from about 2 wt % to about 15 wt % of at least one α,β-unsaturated carboxylic acid ester having 3 to 10 carbon atoms, and
(iv) optionally a derivative of an α,β-unsaturated carboxylic acid other than (iii) in an amount such that (iii)+(iv) is about 15 wt % or less,
wherein the weight percentages of the copolymerized units of the terpolymer ionomer resin are based on the total weight of the terpolymer ionomer resin and the sum of the weight percentages of the terpolymer ionomer resin's copolymerized units is 100 wt %, and wherein at least a portion of the terpolymer ionomer resin's carboxylic acid groups of the α,β-unsaturated carboxylic acid are neutralized to form an ionomer comprising carboxylate groups having sodium counterions.

11. The ionomer resin composition as claimed in claim 1, wherein each of the alkoxy groups of the dialkoxysilane adhesion promoter individually contains from 1 to 3 carbon atoms.

12. The ionomer resin composition as claimed in claim 11, wherein in addition to the alkoxy groups the dialkoxysilane adhesion promoter also contains an active chemical group for bonding into virgin alkali metal-neutralized ethylene acid copolymer.

13. An interlayer sheet comprising the ionomer resin composition as claimed in claim 1.

14. The interlayer sheet as claimed in claim 13, having a thickness ranging from about 320 μm or more to about 1850 μm or less.

15. A glass laminate, comprising the interlayer sheet as claimed in claim 13.

16. A process for making an ionomer resin composition comprising the step of intimately mixing a virgin sodium-neutralized ethylene acid copolymer and a recycle material comprising a dialkoxysilane adhesion promoter.

17. The process as claimed in claim 16, comprising the steps of feeding said virgin sodium-neutralized ethylene acid copolymer and recycle material into an extruder and intimately mixing the copolymer and recycle material under melt conditions to produce a substantially uniform mixture followed by forming said substantially uniform mixture into a final shape by melt extrusion or molding.

18. The process as claim in claim 17, wherein the ionomer resin composition is as set forth in claim 1.
